(19) United States
(12) Patent Application Publication
(10) Pub. No.: US 2008/0135397 A1
(43) Pub. Date: Jun. 12, 2008

(54) Device, Method And Use For Continuously Carrying Out Photochemical Process With Thin Optical Layer Thicknesses, Narrow Residence Time Distribution And High Throughputs

(75) Inventors: Wolfgang Ehrfeld, Mainz (DE); Frank Schael, Darmstadt (DE); Oliver Koch, Bamberg (DE)

Correspondence Address: NORRIS, MCLAUGHLIN & MARCUS, P.A., 875 THIRD AVE, 18TH FLOOR, NEW YORK, NY, 10022, US

(73) Assignee: EHRFELD MIKROTECHNIK BTS GMBH, WENDELSHEIM (DE)

(21) Appl. No.: 11/814,299

(22) PCT Filed: Jan. 18, 2006
(86) PCT No.: PCT/EP06/00388

§ 371 Date: Dec. 20, 2007

(30) Foreign Application Priority Data
Jan. 27, 2005 (DE) 10 2005 003 966.9

(51) Int. Cl. B01J 19/12; B01J 19/00

(52) U.S. Cl. 204/157.15; 422/129

(57) ABSTRACT

Device for continuously carrying out photochemical reactions, with which exposure of small optical layer thicknesses is facilitated with a narrow residence time distribution and high throughput rates.

The invention relates to a device for continuously carrying out photochemical reactions, with which exposure of small optical layer thicknesses is facilitated with a narrow residence time distribution and high throughput rates.

Photochemical reactions can be carried out particularly advantageously with the aid of the microreaction technique. In the microreaction technique, components whose smallest characteristic dimensions typically lie in the range of from a few micrometers to a few millimeters are used for the basic operations of the method technique. Small dimensions are particularly advantageous when substance, heat and/or radiation transport is intended to be carried out in the technical apparatus of the method. The technically expedient conduct of photochemical reactions, in which radiation transport processes are central steps, requires above all economically optimal utilization of the beam sources used. To this end, the radiation entering the solution is to be utilized optimally in order, on the one hand, not to leave any radiation unused but, on the other hand, so that the starting solution to be exposed is reacted as quantitatively as possible. According to the Lambert-Beer law, the extinction depends on the optical layer thickness, the concentration and the extinction coefficient of the absorbing species. Conventional photoreactors operate with relatively large volumes and conventionally stir the process medium so that maximally high exchange of the process medium is achieved in the vicinity of a transparent wall, through which the radiation is introduced. Furthermore, photoreactors are often operated in a circuit. The effect of the described embodiments is that a compromise between the exposure time and the maximum usable concentration of the starting substance usually has to be found experimentally.

One way of improving performance consists in spatially limiting the process medium to be exposed, so that only a liquid layer is exposed with such a thickness over which the radiation is fully absorbed by the starting substance/substances at the concentration to be used over the entire penetration depth in the process medium. The optimal layer thickness dgo %, at which 90% of the incident radiation is absorbed, can be calculated from the Lambert-Beer law:

d_{90%}=1/(εc)

(ε=extinction coefficient, c=concentration)

A range of photoreactors are known in the prior art. For instance, DE A 10341500.9 describes photoreactors with narrow layer thicknesses in conjunction with a forced flow from the bottom upward along the microchannels (rising film) in order to generate a narrow residence time distribution, and high-power light-emitting diodes as exposure sources.

EP 1 415 707 A1 describes microfluidic photoreactors with photocatalytic elements introduced into the fluid flow. DE 102 09 898 A1 describes photoreactors with a planar transparent covering for carrying out heterogeneously catalyzed chemical reactions in coated channels with a diameter of preferably from 100 to 500 μm.

US 2003/0118 486 A1 describes an arrangement for carrying out parallel chemical reactions in channels with a width of from 10 to 5000 μm. There, essentially, the reaction fluid flows in a two- or three-dimensional arrangement first through photochemical flow cells and subsequently (unexposed) reaction chambers.

EP14002 80 A1 describes a microreactor in which a pressure vessel is fitted. This does admittedly avoid a possible pressure difference between the interior of the reactor and the environment, and therefore possible deformations of the microchannels at high flow rates. According to the prior art, the fitting of suitable exposure sources of sufficient power inside a pressure vessel, so that photochemical applications of the described apparatus would in fact be possible, is possible only with considerable technical outlay.

US2004/0241046A1 describes the structure of a microreactor with a transparent covering, which, although it is suitable for photochemical application, does not ensure sufficient stability of the layer thickness at high throughputs.

US2003/0042126A1 describes an exposure apparatus essentially consisting of two concentric tubes. Here, however, the layer thickness can only be adapted limitedly to the tasks relevant here.

A common feature of all the proposed solutions known to date is that they do not achieve a narrow residence time distribution for the process medium and they can be used only limitedly for high throughputs. Very many microphotoreactors described to date use planar exposure zones. The operation of a photoreactor with throughputs which are suitable for production of chemicals, however, when using small channels, inevitably leads to the creation of a high internal pressure on the generally transparent covering of the channels, which is used for input of the radiation. Even with flow rates of 10 ml/min and an exposure zone with dimensions of 20 μm thickness×10 cm width×10 cm length, for example, this pressure amounts to about 3.2 bar. The pressure loss in such an arrangement depends on the viscosity of the medium used, and rises with increasing viscosity. Here, a dynamic viscosity of 1.3 mPas has been assumed. The estimated pressure is sufficient to cause deformation even of a 1 cm thick glass pane or—without proper installation—even destruction of the glass pane. The effect of deformation is in turn that the dimensions of the channels, in particular the optical layer thickness, change intolerably so that the particular advantage of a microphotoreactor cannot be utilized with high flow rates.

To date, therefore, there are no chemical reactors which are distinguished by exposure in microchannels and which are configured for operation with high flow rates.

Another common feature of all the proposed solutions known to date is that, in system components, different volume elements of the process medium remain for different lengths of time in the reaction space, so that the width of the residence time distribution for the reaction is very large. The effect of this is generally that full chemical reaction does not take place for volume elements which remain only for a comparatively short time in the reaction space, while in other volume elements which e.g. in dead water zones remain for a very long time in the reaction space, the desired photochemical reaction does not take place at all for lack of exposure in the dead water zones, or even undesired consecutive reactions can occur. Optimal values for the throughput, the selectivity and the yield of the reaction can therefore scarcely be achieved.

It is therefore an object of the invention to provide a device which does not have the aforementioned disadvantages of the prior art.

Surprisingly, a device for carrying out photochemical reactions in a continuous process has now been found, containing a reaction zone with microchannels in which the layer thickness of the medium to be exposed remains constant in exposure direction independently of the fluidic pressure.

The invention therefore relates to a device which is preferably used for carrying out photochemical reactions in a continuous process, containing an exposable reaction zone with microchannels in which the layer thickness of the reaction medium to be exposed remains constant in the exposure direction independently of the fluidic pressure.

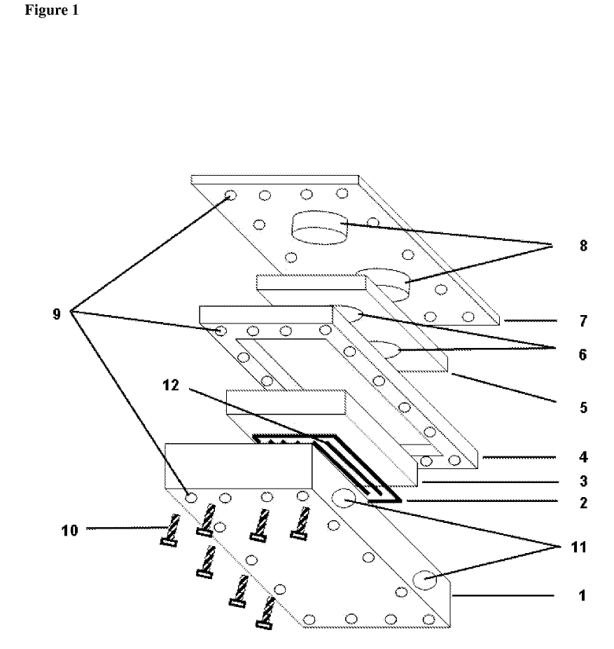

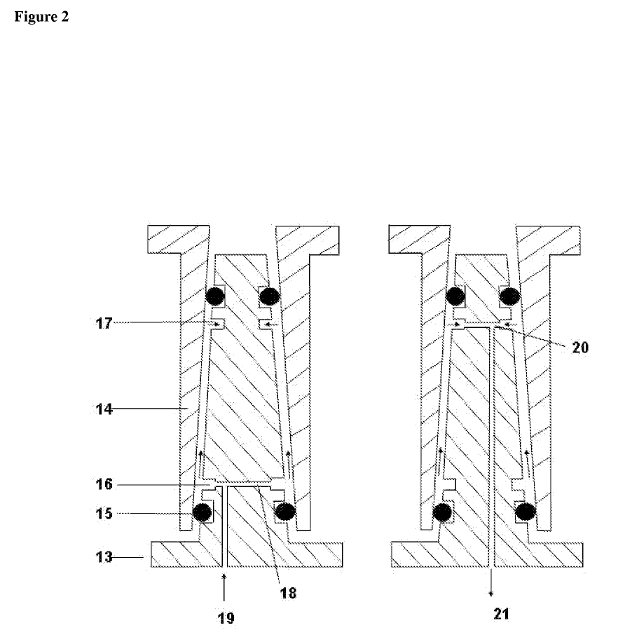

The device according to the invention preferably has a structure according to FIG. 1 or 2. According to Figure (1), besides the light source (radiator) needed for the photoreactions, for example LEDs, lasers, discharge lamps, it preferably contains at least one reaction zone plate (1) with suitable media feeds and discharges (11), at least one sealing element, for example an O-ring (2), a transparent covering (3), a fastened rubber mat as a support element (5) with openings for the radiators (6), and optionally a holding plate (7) for the radiators (8).

According to FIG. 2, besides the light source needed for the photoreactions, the device preferably contains at least one axisymmetric reaction zone body (13) with suitable media feeds and discharges (17-21), at least two sealing elements, for example O-rings (15), and a transparent covering (14). The transparent covering (14) is preferably a conically processed tube.

In both cases, the light source is preferably arranged so that the medium is exposed from the outside through the transparent covering.

The medium to be exposed preferably comprises substances which are liquid or gaseous at the reaction temperature. This also includes substances which are solid at room temperature but which change their physical state to liquid or gaseous at the reaction temperature. All inorganic or organic, or even metalorganic substances may therefore be used. The reaction temperature preferably lies in the range of from −60 to +200° C., particularly preferably 0-30° C.

The microchannels of the reaction zone may extend straight, curved, in serpentine or angled fashion, the reaction fluid preferably flowing from the bottom upward along the microchannels (rising film). These channels preferably have a width of from 10 μm to 50 cm, preferably from 10 μm to 25 cm, more particularly preferably from 10 μm to 1000 μm.

One embodiment provides a film which flows through the exposure zone in a width of preferably from 1 to 50 cm and a corresponding layer thickness. This embodiment imposes particular requirements on uniform flow in the treatment zone and careful technical configuration of the exposure zone, although it makes do without further compartmentalization.

The layer thickness of the medium to be exposed is particularly preferably from 10 to 1000 μm. The layer thickness of the medium to be exposed preferably remains constant in the device according to the invention within the measurement accuracy of about 1 μm over an extent of about 250 mm in the exposure zone.

In one embodiment of the invention, the device according to the invention is characterized in that the reaction zone is covered by transparent material, this being tensioned via at least one support element. For the transparent plate, this tension causes the formation of a counter-pressure against the fluidic pressure. The counter-pressure holds the plate in the desired shape and position.

The transparent material is preferably made of glass (for example quartz glass, borosilicate glass or the like) or transparent plastics (for example PMMA, PVC, polycarbonate, PET, PVDF, PTFE, PI), which is preferably used in the form of plates.

The support elements in the context of the invention are preferably resilient materials, such as rubber mats or elements, mechanical elements made of other suitable materials, preferably metal or plastics, which can be pressed onto the transparent covering by means of a suitable device. A certain resilience of the support elements ensures that maximally homogeneous tensioning of the glass plate is achieved.

The device according to the invention for carrying out photochemical reactions in a continuous process preferably comprises an arrangement of a reaction zone plate, into which microchannels for media supply are incorporated or produced in another way, for example by lithography, a transparent covering, one or more resilient support elements and suitable beam sources.

Onto this glass plate, plates preferably of resilient material are then applied which
(i) support of the glass plate on the other side from the fluid, apply a counter-pressure and therefore prevent curvatures, but also at the same time
(ii) have openings for the input of radiation.

The openings are preferably only so large that the exposure device can occupy them, or the radiation can pass through them sufficiently.

In order to produce the microchannels, either they may be incorporated microtechnologically into the reaction zone plate according to conventional methods or, in planar or conical embodiments, it is also possible to use spacers, for example made of wires or of metal or plastic sheets, for example in rings or other bodies, which are placed between the transparent covering and the reaction zone plate. The metal or plastic sheets are preferably chemically inert and geometrically stable.

In a preferred embodiment, planar reaction zone plates are used into which the microchannels are incorporated by microtechnological fabrication methods or are produced by using one or more spacers made of metal or plastics for the transparent covering. So long as the flow conditions with the parameters being used so permit, it is also possible to use a wide liquid front which has the desired small layer thickness but is not subdivided laterally into individual channels. In this embodiment, the support construction for generating a counter-pressure consists of a grid, a mat with suitable openings or individual support elements made of resilient material, preferably elastomer plastics (for example Viton, rubber, latex, silicone).

In another preferred embodiment of the invention, the reaction zone and the transparent covering which encloses it are configured so that they cannot be deformed mechanically by the fluidic pressure.

This may, for example, be achieved by configuring the reaction zone and the covering coaxially, see for example FIG. 2. Also preferably, the reaction zone and the covering consist of a plurality of uprightly arranged, conically processed bodies and tubes fitted in to one another, the layer thickness defined by the spacing of the two bodies being adjusted by displacing the two elements vertically.

The outer body then preferably consists of a precisely processed quartz tube for covering the fluid channels, and the inner body preferably of metals (for example stainless steel, titanium, nickel-based alloys). The spacing between the bodies, and therefore the layer thickness of the reaction fluid, is determined by vertically displacing the uprightly standing conical bodies. The displacement may be carried out by a suitable mechanism.

The coaxial arrangement may furthermore be configured so that the inner body is made from a tube which is slotted at least at one position. The tube is outwardly sealed by a Teflon rod at the slot, and can be pulled together precisely by means of a clamp arrangement. In this way, the diameter of the inner body is variable and ensures an adjustable layer thickness. In this arrangement, the layer thickness may be checked experimentally, for example by introducing a chemical actinometer with a suitable wavelength sensitivity and concentration.

In a preferred embodiment, the reaction zone lies on the lateral surface of a convexly shaped body (reaction zone body) preferably made of steel or ceramic, and is enclosed by a transparent tube so that the desired layer thickness of the process medium is achieved. At the ends, the tube and the body are centered by suitable frames and supplied with fluid. For thermal regulation, the reaction zone body is preferably permeated by channels through which the thermal regulating medium can be delivered. The temperature of the body is measured by a temperature sensor. The exposure sources are then preferably fastened on a further tube which, for example, may be made of plastic or steel. This tube is fitted over the transparent tube and the support elements are placed between the two tubes. The support elements may consist of bars, which are distributed lengthwise on the outer side of the transparent tube.

Glasses (for example quartz glass, borosilicate glass or the like) or transparent plastics (for example PMMA, PVC, polycarbonate, PET, PVDF, PTFE, PI) in the form of processed tubes are preferably used as transparent materials for the covering of the reaction zone in this embodiment of the invention.

In all the described embodiments of the invention, the exposure time for the photochemical reactions can be adjusted according to requirements by changing the flow rate of the process medium and/or changing the geometrical size of the reaction zone.

The devices according to the invention are distinguished in that the reaction fluid preferably flows through them against the force of gravity, so that a narrow residence time distribution is generated inside the device. Owing to the forced flow in a small layer thickness against the force of gravity (rising film), the fluid experiences a resistance which is added to the known adhesive effect on the walls and, above all, flattens the usually parabolic distribution of the flow rate in the small channels. This leads to the formation of a narrow residence time characteristic.

Organic or inorganic semiconductor light sources such as diode lasers and light-emitting diodes, or combinations thereof, are preferably used as exposure sources. Discharge lamps may likewise be used. A particularly preferred embodiment uses high-performance LED arrangements which are distinguished by a small spectral bandwidth, high efficiency and compact structure. The exposure dose achievable overall in the microphotoreactor is given by the total number of exposure sources used and the radiation power utilized in the device.

Owing to the compact exposure sources, a device is obtained which can be readily adapted in respect of the required exposure wavelength and dose for a synthesis to be carried out. The device according to the invention makes it readily possible to set up a wavelength profile long the exposure zone. For instance, exposure may be carried out at the start with a particular wavelength or in a particular wavelength range, but with a different one at the end. In this way, consecutive photochemical reactions or multistage reactions can be carried out optimally. The variation of the wavelength may be achieved by using different beam sources or, in the case of semiconductor light sources (laser diodes, light-emitting diodes), by varying the cooling temperature or the operating current, the latter leading to substantially finer regulation of the exposure wavelength. Semiconductor light sources generally exhibit a temperature- and current-dependent emission spectrum.

In another embodiment of the invention, the microchannels may be coated with catalytically active substances in and outside the reaction zone. Such heterogeneously catalytically active coatings may influence or initiate the photochemical reaction per se, or may affect a preceding or subsequent reaction step.

Various metal oxides, for example TiO2, Al2O3, SiO2, ZrO2, zeolites, organic dyes such as phthalocyanine dyes immobilized on suitable supports, or mixtures of said substances and subclasses thereof may be used as catalytically active substances. The coatings may for instance be applied by sol-gel methods.

The microchannels in the planar or axisymmetric devices may also be produced by wires placed between the covering and the reaction zone plate.

Lastly, the microchannels may also be incorporated into the reaction zone plate with the aid of microtechnological fabrication methods. The microchannels per se may be configured to be straight, curved, serpentine or angled.

Serpentines offer advantages particularly for long exposure times. Angled microchannels may be configured so that diffuse mixing within the microchannels is reinforced by deliberate deflection of the reaction fluid. In this way, fluid zones which lie at the rear end of the channel can be brought forward and thus exposed to a higher exposure dose.

Although photochemical processes per se are generally not very temperature-dependent, it is common for there to be side or consecutive reactions which necessitate temperature control. Furthermore, many radiators exhibit significant emission in the infrared spectral range, which can lead to heating of many media. Thermal regulation of the reaction zone in the device is therefore optionally possible. This is preferably carried out by channels, introduced into the plate or the cylinder, in which thermal regulating fluid can circulate. The small fluid layers being used then ensure effective heat transfer and the temperature can then be carried out very well by a temperature sensor fitted into the reaction zone plate or the reaction zone body. By expedient arrangement of the thermal regulating channels, it is also possible to set up temperature profiles which allow thermal control of possible consecutive and side reactions.

In another preferred embodiment of the device, it contains further micromethod technology functional elements such as micromixers, microseparators, microreactors or microheat-exchangers etc., so that a very compact chemical processing system with a photochemical exposure step is obtained.

The invention also relates to a method for carrying out chemical reactions by using the devices according to the invention. This device is preferably suitable for producing natural substances and pharmacologically active agents from homogeneous initial solutions without or with solid components with well-defined particle sizes in the nanometer range, for example caprolactam and derivatives, rose oxide and similar odorous and flavoring substances, isomerically pure vitamin A and other olefins, halogenated compounds and many more. The exposure sources, materials, process parameters and peripherals are respectively to be selected accordingly.

The invention furthermore relates to the use of the device according to the invention for carrying out chemical reactions, for example photocyclizations, photonitrosations, photoisomerizations, photohalogenations and photooxidations.

Exemplary embodiments of the invention are represented in the drawings and will be described in more detail below, but without implying any limitation.

### LIST OF REFERENCES

1 bottom plate with reaction zone
2 O-ring
3 quartz glass plate
4 flange fixture for quartz glass plate
5 support element (rubber mat)
6 openings for radiators in the support element
7 support plate for radiators
8 radiators
9 screw holes
10 screws
11 media feed and discharge
12 spacers made of metal or plastic sheet
13 conical stainless steel cylinder with base
14 conical quartz tube with base
15 O-ring
16 circumferentially milled groove for media feed
17 circumferentially milled groove for media discharge
18 inner-lying bore for media feed
19 media feed
20 inner-lying bore for media discharge
21 media discharge

FIG. 1 shows a schematic representation of a preferred embodiment of the device with a planar reaction zone plate (1). The device consists essentially of a reaction zone plate (1) with suitable media feeds and discharges (11), an O-ring (2) which seals the reaction zone, a quartz glass plate (3), a flange fixture (4) for holding the quartz glass plate, a rubber mat as a support element (5) with openings for the radiators (6), a holding plate (7) for the radiators (8). The device is assembled by suitable screws (10) and screw holes (9) in the components of the device. The microchannels are formed by spacers made of metal or plastic sheets (12), which are placed between the quartz glass plate and the reaction zone plate and are pressed on by means of the frame. Different layer thicknesses of the medium to be exposed are achieved by using sheets of different thickness. The back-pressure is exerted onto the quartz glass plate by the resilient rubber mat (5), which is pressed on precisely by means of a frame. The device is preferably set up so that the medium flows over the reaction zone plate against the force of gravity.

FIG. 2 shows two inter-merging sections (a) and (b) of a preferred axisymmetric embodiment of the device according to the invention for producing adjustable layer thicknesses. The embodiment consists essentially of a stainless steel body (13) shaped conically on the outside, which may be provided with a base in order to improve stability, of a quartz tube (14) processed conically on the inside and fitted over (13), which may likewise be provided with a base, O-rings (15) for sealing the bodies (13) and (14). The bodies (13) and (14) are centered by means of lids and, where necessary, sealed. The thermal and reaction fluids are supplied and discharged via the lids. The lids are not represented in the drawing. The delivery of the medium to be exposed through the device is illustrated with the aid of the arrows. Through the media feed (19) and at least one inner-lying bore in the stainless steel body (18), the medium is fed (16) to a groove milled circumferentially in the stainless steel body, from where the liquid enters the gap between (13) and (14) and flows upward. In the circumferentially milled groove (17), the exposed medium is collected and leaves the device via at least one bore (20) and the media discharge (21). The layer thickness of the medium to be exposed is defined by the width of the gap between (13) and (14), and can be varied and adapted to requirements by displacing (13) and (14) relative to one another. To this end a suitable adjustment mechanism is used, which is not represented in FIG. 2. Spacer elements for increasing the precision of the layer thickness may be fitted between (13) and (14).

1. A device for carrying out chemical reactions, containing an exposable reaction zone with microchannels in which the layer thickness of reaction medium supplied to said reaction zone remains constant in said microchannels independently of the fluidic pressure, wherein the reaction zone is covered by transparent material which is tensioned via at least one support element and/or the reaction zone and covering consist of a plurality of coaxial, conically shaped bodies and tubes fitted into one another, in which the layer thickness defined by the spacing of the two bodies is adjustable by displacing the two elements along their common rotation axis.

2. A method for carrying out photochemical reactions, which comprises carrying out said reactions in the device of claim 1.

3. (canceled)
